(19) United States
(12) Patent Application Publication
(10) Pub. No.: US 2007/0216237 A1
(43) Pub. Date: Sep. 20, 2007

(54) Industrial Gear Unit

(75) Inventor: Dirk-Olaf Leimann, Edegem (BE)

Correspondence Address: YOUNG & THOMPSON, 745 SOUTH 23RD STREET, 2ND FLOOR, ARLINGTON, VA, 22202, US

(73) Assignee: HANSEN TRANSMISSIONS INTERNATIONAL NAAMLOZEVENNOOTSCHAP, Edegem (BE)

(21) Appl. No.: 11/596,393

(22) PCT Filed: May 27, 2005
(86) PCT No.: PCT/BE05/00086

§ 371 Date: Nov. 14, 2006

(30) Foreign Application Priority Data
May 27, 2004 (GB) 0411870.9

(51) Int. Cl. F16H 57/04; H02K 9/20

(52) U.S. Cl. 310/54; 74/606 A

(57) ABSTRACT

An industrial gear unit including a housing (14) which contains lubricated gear components, a water coolant device (1) which defines, at least in part, a fluid chamber (3) and fluid inlet (4) and outlet parts, and a retention element (32) which secures the water coolant device to the housing, the water coolant device defining a contact surface (5,6) and the housing providing an external contact surface against which the contact surface of the water coolant device is secured by the retention element.

This invention relates to an industrial gear unit and in particular, though not exclusively, to a gear unit having a water coolant device which enables a flow of water coolant to remove heat from the housing of the gear unit.

Industrial type gear units operate typically over a wide range of power ratings and particularly when a gear unit is operating close to its maximum designed power rating friction loses within the gear unit can generate a significant heating effect.

Although the lubricating oil commonly used for lubrication of the gear unit assists in transferring heat away from the heat generating friction surfaces within the gear unit, the capacity for heat transfer via the lubricating oil is limited. The lubricating oil will transmit heat to the gear unit housing and the ability of the oil to remove heat from the friction surfaces will depend in part on the extent to which heat is removed from the housing, for example by free convection of air externally of the housing. Commonly, however, it is found that convection of air is not adequate to remove heat sufficiently quickly to avoid unduly high temperatures arising within the gear unit. To avoid that problem and potential deterioration of lubricating effect it is known to employ cooling fans which direct a forced flow of air to the outside of the gear unit housing thereby to improve the temperature gradient between the friction generating surfaces within the gear unit and the gear unit housing.

In contrast to providing an external forced flow of cooling air it is known also to provide cooling coils within the gear unit and through which water may be circulated to cool the oil within the gear unit. In another alternative the lubricating oil is pumped through an external heat exchanger. Yet another proposal comprises providing a specially constructed housing having two walls between which cooling water may flow.

Whilst the provision of a forced air flow is relatively cheap, it is not so effective as, for example, the provision of cooling coils or rings. However the provision of cooling coils does suffer the disadvantage of a potential risk of cooling water leaking into the lubricating oil, with potentially serious consequences to the ability of the lubricating oil to provide effective lubrication. The risk of water leakage may be avoided by forced circulation of the oil through an external heat exchanger, or provision of a twin walled housing, but such solutions are relatively expensive.

The present invention seeks to provide a gear unit having an improved means for achieving effective cooling of the housing of the gear unit.

In accordance with one aspect of the present invention there is provided an industrial gear unit comprising a housing which contains lubricated gear components, a water coolant device which defines, at least in part, a fluid chamber and fluid inlet and outlet ports, and retention means which secures the water coolant device to the housing, said water coolant device defining a contact surface and said housing providing an external contact surface against which said contact surface of the water coolant device is secured by said retention means.

The invention is particularly applicable to gear units and water coolant devices suitable for use with housings of gear units which have a capacity rating of at least 373 Joules/per sec (0.5 horsepower).

The water coolant device preferably comprises a cooling surface which is provided with ribs or other formations of a substantially non-planar type thereby to increase the cooling surface area of the inside or outside surface of the water coolant. Additionally the gear unit housing may be provided with ribs or like formations to provide an enhanced heat transfer capability to water contained by the water coolant.

The inner surface of the water coolant device, being that which, in use, is exposed to the cooling water, may be selectively profiled thereby selectively to guide the flow of cooling water in a preferential manner in which there is positive flow of cooling water over substantially the whole of that part of the gear unit housing surface over which the water coolant device extends. This assists to avoid stagnation points at which there would be no flow and effective removal of thermal energy.

Similarly the housing may be provided with ribs or like formations for the purpose of selectively directing the flow of cooling water.

The present invention teaches that preferably at least a part of the water coolant device is adapted to be secured to that part of a gear unit housing which, in a non-operative state of the gear unit, lies below the recommended level of oil in the gear unit housing. Alternatively or additionally, if the gear unit housing is of a construction in which, in use, a zone of the housing tends to be subjected to a forced spray of lubricating oil from rotating components within the gear unit housing, said water coolant device may be positioned substantially wholly or in part adjacent that part of the gear unit housing, externally thereof.

The present invention further teaches that the water coolant device may be secured to the housing by means of at least one clamp which may engage with a location formation provided on the gear unit housing. Thus the need for special machining of the gear unit housing, for example to provide screw-threaded apertures, may be avoided.

The water coolant device may be formed from, for example, sheet metal and said sheet material may have been subject to a stamping operation or like process to form the aforedescribed ribs or like non-planar formations.

Alternatively the water coolant device may be formed by moulding or casting of a material such as cast iron, other metallic material or a plastics material.

The present invention teaches that the water coolant device may have a contact surface, such as a peripheral sealing surface, which has a shape profile slightly different from that of a potentially confronting surface region of the gear unit housing, but which conforms to said surface of the gear unit housing when the water coolant device is brought to bear against the housing. Thus it is envisaged that the water coolant device may be elastic and deformable such that tightening of clamps to secure the water coolant device to the housing also results in at least a part of the water coolant device being elastically deformed in a manner which assists in providing firm contact between the water coolant device and housing and to resist effects of vibrations arising in use of the gear unit.

In the case of an open-sided type of water coolant device which defines a peripheral sealing surface that elastic deformation assists in providing a good compression of any sealing material or component provided between the casing member and gear unit housing. It is believed, in particular, that the provision of an open-sided type of water coolant device of a kind which becomes elastically deformed when secured to the housing of the gear unit has the advantage of providing enhanced resistance to leakage when subject to vibrations arising in use of the gear unit.

From the foregoing it will be understood that whilst the present invention envisages that typically the water coolant device shall define only part of a chamber through which cooling water may flow, with the remainder of the chamber being defined for example by the housing of a gear unit, the invention teaches also that the water coolant device may substantially wholly define the chamber. In that case it is preferred that the part of the water coolant device which confronts the housing of the gear unit shall be of a shape which closely corresponds with that of the housing thereby to facilitate a good transfer of thermal energy by conduction from the housing to the water coolant device.

The mutually confronting surfaces of the gear unit housing and the water coolant device may each be machined surfaces or one or each of said surfaces may be rough as cast, or as moulded.

Embodiments of the present invention will now be described, by way of example only, with reference to the accompanying diagrammatic drawings in which:

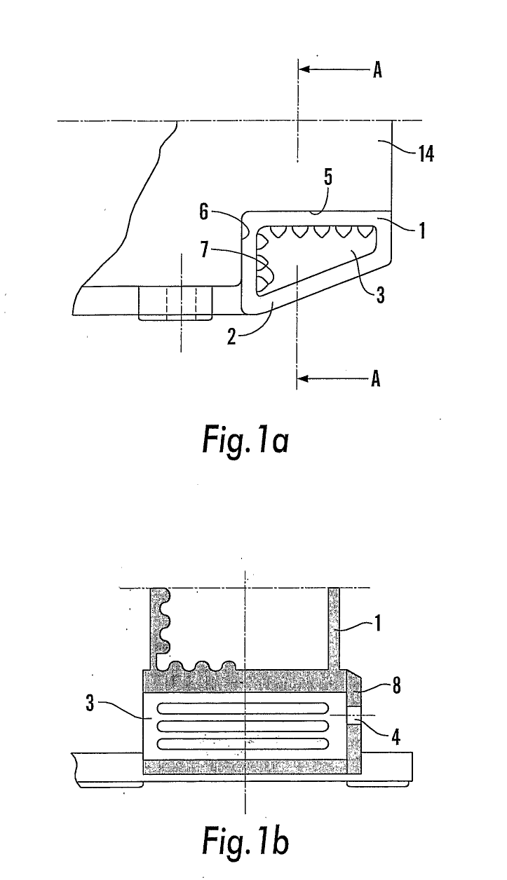

FIGS. 1A and 1B show respectively a side view and section on the line A-A of FIG. 1A of a gear unit housing and water coolant device in accordance with one embodiment of the present invention;

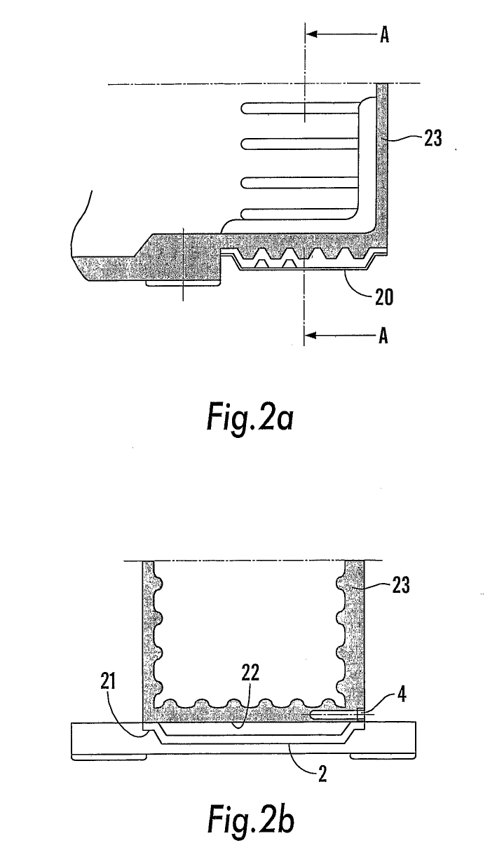

FIGS. 2A and 2B show respectively views similar to those of FIGS. 1A and 1B for another embodiment of the present invention;

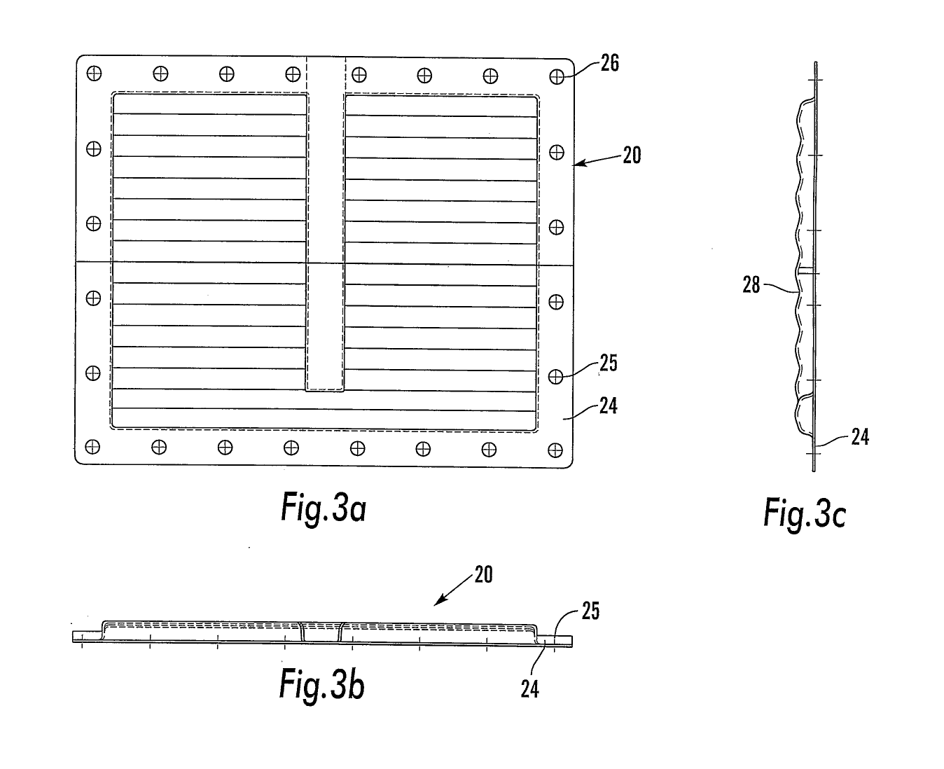

FIGS. 3A, B and C show respectively plan, side and end views of a water coolant device in accordance with another embodiment;

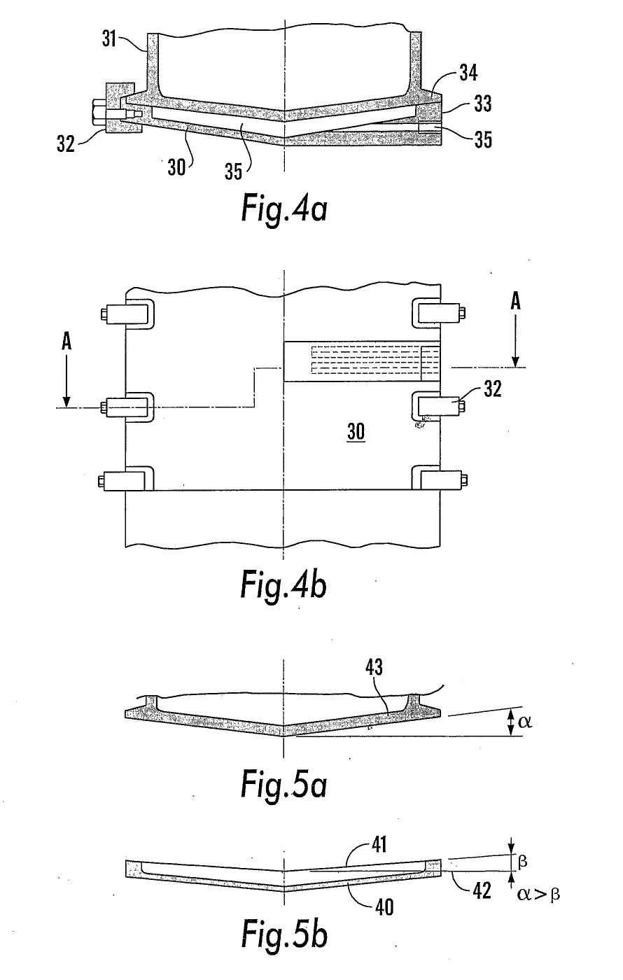

FIGS. 4A and 4B show respectively a sectional view on the line A-A of FIG. 4B and a plan view of part of a water coolant device and gear unit housing constructed in accordance with a further aspect of the present invention;

FIGS. 5A and 5B show features of assembly of a water coolant device to a gear unit housing;

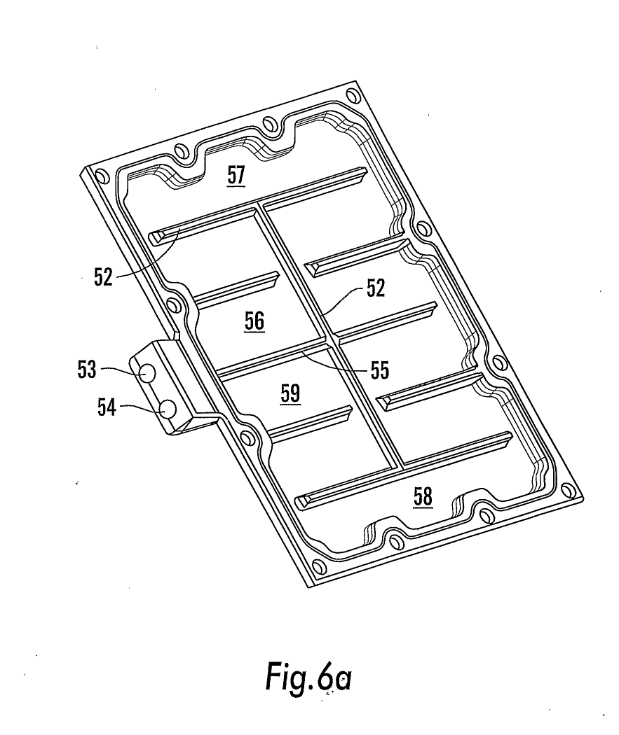

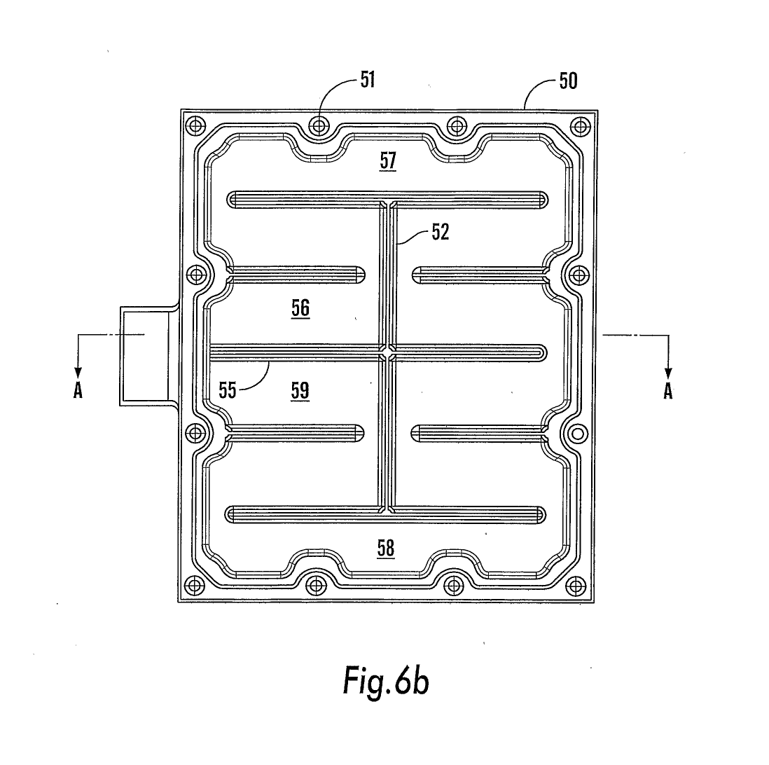

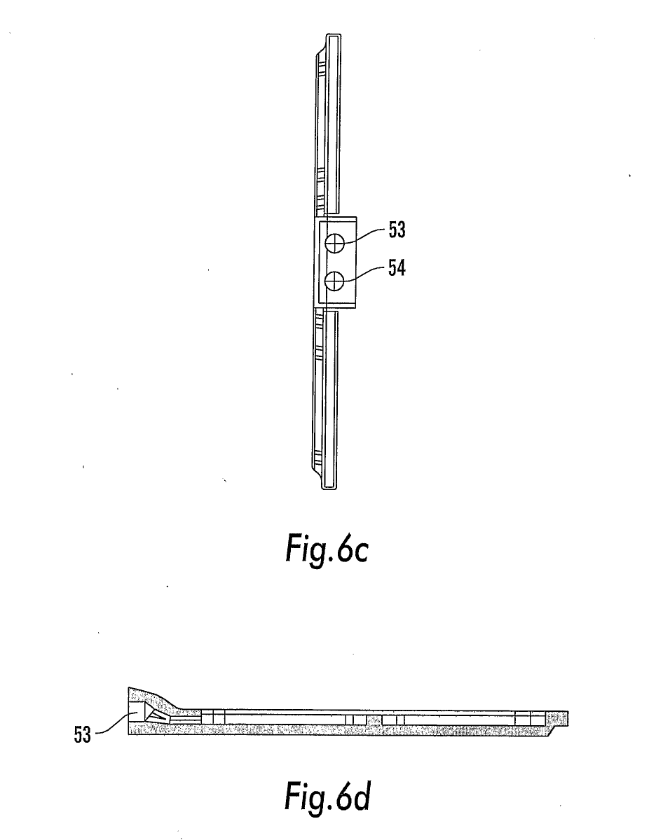

FIGS. 6A, B, C and D show respectively perspective, plan, end and section on a line X-X of FIG. 6B of a water coolant device in accordance with yet another aspect of the present invention, and

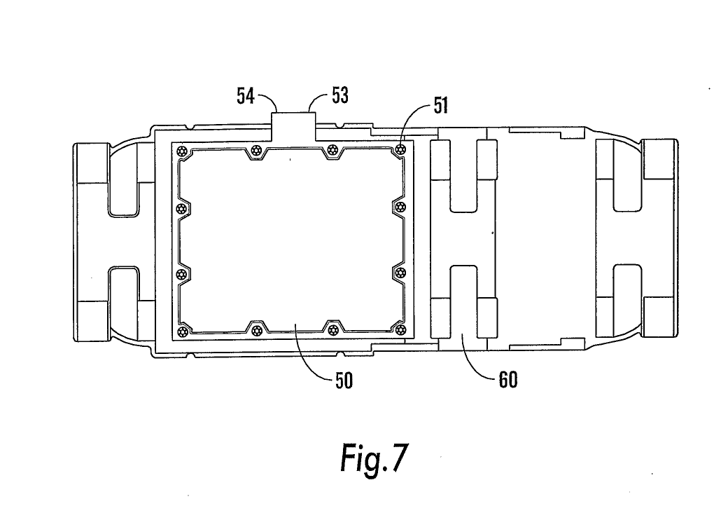

FIG. 7 shows the water coolant device of FIG. 6 in situ secured to the sump region of a gear unit housing.

FIG. 1 shows part of an assembly of a gear unit housing 14 having a water coolant device 1 secured thereto. The water coolant device 1 comprises a casing wall structure 2 which defines a chamber 3 through which coolant water may be circulated via an inlet port 4 in an end plate 8, and exit via an outlet port (not shown). The casing 2 is shaped to have surfaces 5 and 6 which conform to and bear closely against the confronting surface regions of the gear unit housing 14. The inner regions of the casing, internally of the parts of the casing which confront the regions 5 and 6, are provided with rib structures 7 which assist in enhancing heat transfer.

In the construction of FIGS. 2A and 2B the water coolant device comprises a casing member 20 having a peripheral sealing region 21 which confronts and sealingly bears against a lower surface 22 of part of a gear unit housing 23. The casing member 20 is shown in more detail in FIGS. 3A, B and C. The casing member 20 is formed from pressed sheet metal and has a peripheral sealing region 24 which is provided with a plurality of apertures 26 to enable the casing member 20 to be secured to a gear unit housing by means of screws (not shown). The casing member is provided with rib-like formations 28 which are positioned to preferentially direct flow of coolant.

FIGS. 4A and 4B show a casing member 30 secured to a gear unit housing 31 by means of a plurality of peripheral clamps 32. The clamps act between an edge region 33 of the water coolant casing member and a rib 34 at the sump region of the gear unit housing 31. The casing member 30 is provided with an inlet port through which coolant water may flow into a chamber 35 defined between the casing member 30 and the housing 31. A sealing gasket (not shown) is provided between the peripheral region 33 of the casing member and the confronting member of the housing 31.

FIGS. 5A and 5B show a further feature which may be employed in the context of the construction shown in FIG. 4. The casing member 40 shown in FIG. 5B has a sealing surface 41 the angles of parts of which lie inclined to the planar direction 42 at an angle less than the angle beta corresponding surface angle alpha of a part of the gear unit housing 43 to which the casing member 40 is to be fitted (see FIG. 5A). When the clamps 32 are employed to secure the outer edge regions of the casing member (as viewed in FIG. 5B) to the gear unit housing 43 the casing member 40 becomes elastically deformed and bears tightly in a fluid tight manner against the confronting surfaces of the housing 43 thereby to achieve a good compression seal.

FIGS. 6A to 6D show another casing member 50 of a cast metal construction and provided with a plurality of peripheral apertures 51 whereby it may be secured by retention screws to a gear unit housing. The casing member comprises a plurality of internal rib formations which provide a tortuous path for flow of fluid. A water inlet 53 communicates with a zone 56 and water then flows in a tortuous manner from the zone 56 via end 57 and then to the other end 58 before flowing onwards to the zone 59. Zone 59 is separated from zone 56 by a rib 55 that extends continuously from between the aforementioned inlet port 53 and an outlet port 54 to a lengthwise extending rib 52. FIG. 7 shows the aforedescribed casing member 50 secured to the sump region at the underside of a gear unit housing 60.

From the foregoing it will be understood that the present invention provides an effective and economic means by which cooling can be achieved. Furthermore that is achieved without any significant risk of cooling water entering the gear unit housing and contaminating the lubricating oil.

1-12. (canceled)

13. An industrial gear unit comprising a housing (31) which contains lubricated gear components, characterized in that it comprises an open-sided type of water coolant device which consists mainly of a casing member (30,40); fluid inlet and outlet ports; and removable retention means (32), which secures the water coolant device to the housing (31,43); wherein said water coolant device defines only part of a fluid chamber (35) and comprises a peripheral sealing surface (41) which engages the gear unit housing (31,43) thereby in combination with the housing (31,43) to define a fluid chamber (35) in which cooling water may be contained or flow between said inlet and outlet ports.

14. A gear unit according to claim 13, wherein, a sealing material or gasket is provided between the peripheral sealing surface (41) of the water coolant device (40) and the gear unit housing (43).

15. A gear unit according to claim 13, wherein, by securing the water coolant device (30) to the housing (31) with the retention means (32), a compression of the sealing material or gasket is achieved.

16. A gear unit according to claim 13, wherein, prior to assembly with the gear unit housing, the water coolant device (40) has a shape profile different from that of the confronting surface of the gear unit housing (43) and is deformable to a shape in which it conforms to said confronting surface of the gear unit housing when the retention means (32) acts to secure the water coolant device (40) to the housing (43).

17. A gear unit according to claim 16, wherein the deformation of the water coolant device (40) assists in providing a compression of the sealing material or gasket between the water coolant device (40) and the gear unit housing (43).

18. A gear unit according to claim 13, wherein the gear unit has a capacity rating of at least 373 joules/per sec (0.5 horsepower).

19. A gear unit according to claim 14, wherein the retention means (32) secures at least part of the water coolant device (30) to that part of the gear unit housing (31) which is below the level of lubricating oil within the housing when the gear unit is in a non-operative state.

20. A gear unit according to claim 13, wherein, in use of the gear unit, the gear components cause lubricant to impact a zone of the housing and wherein at least part of said water coolant device is secured to said zone of the housing, externally thereof.

21. A gear unit according to claim 13, wherein the gear unit housing comprises a location formation (34) and the retention means (32) comprises a clamp which co-operates with
